(19) United States
(12) Patent Application Publication
(10) Pub. No.: US 2009/0278748 A1
(43) Pub. Date: Nov. 12, 2009

(54) ANTENNA DEVICE AND ELECTRONIC DEVICE USING SAME

(76) Inventors: Motohiko Sako, Osaka (JP); Akihiko Iguchi, Osaka (JP); Yuki Satoh, Gifu (JP)

Correspondence Address: WENDEROTH, LIND & PONACK L.L.P., 1030 15th Street, N.W., Suite 400 East, Washington, DC, 20005-1503, US

(21) Appl. No.: 12/159,654

(22) PCT Filed: Feb. 8, 2007
(86) PCT No.: PCT/JP2007/052260

§ 371 Date: Jun. 30, 2008

(30) Foreign Application Priority Data
Mar. 6, 2006 (JP) 2006-059154

(51) Int. Cl. H01Q 1/50; H01Q 1/24; H01Q 1/38

(52) U.S. Cl. 343/702; 343/860; 343/700 MS

(57) ABSTRACT

The antenna device comprises a ground substrate serving as ground, a feeder portion formed on the ground substrate, a first conductor connected to the feeder portion, and a second conductor being substantially equal to the first conductor in conductor length, which is connected to the ground substrate and disposed substantially parallel to the first conductor with a space therebetween. And, the first conductor and the second conductor are electrically connected to each other between each tip and a portion substantially at least ⅓ in conductor length of each conductor from each tip.

### TECHNICAL FIELD

The present invention relates to a folded antenna device and electronic device using the same.

### BACKGROUND ART

Recently, an antenna device called “folded monopole” which is folded at the center thereof with one end connected to a feeder portion and the other end connected to a ground substrate is used as an antenna device of a portable terminal. A conventional folded monopole antenna device will be described with reference to FIG. 9A to FIG. 9D.

FIG. 9A is a schematic diagram showing the configuration of conventional antenna device 1. Conventional folded monopole antenna device 1 is installed on the ground substrate of a portable terminal. As shown in FIG. 9A, conventional antenna device 1 includes a ground substrate of a portable terminal serving as ground 2, feeder portion 3 formed on the ground substrate of the portable terminal, first conductor 4 connected to feeder portion 3, and second conductor 5 connected to the ground substrate and disposed substantially parallel to first conductor 4 with a space therebetween, which is substantially equal to first conductor 4 in conductor length. Also, tips 6 of first conductor 4 and second conductor 5 are electrically connected to each other.

The operation of conventional antenna device 1 will be described in the following. Conventional antenna device 1 having such a configuration resonates at the primary resonance frequency, secondary resonance frequency and tertiary resonance frequency in the order of lower frequency levels.

FIG. 9B is a schematic diagram for describing current distribution at the primary resonance frequency band of antenna device 1. As shown in FIG. 9B, the current on antenna device 1 at the primary resonance frequency band has a substantially four times longer wavelength as against each conductor length. And, in first conductor 4 and second conductor 5, the extremely large value (so-called current loop) of the current is formed at the end of feeder portion 3, while the extremely small value (so-called current node) of the current is formed at each tip 6. At the primary resonance frequency band, the currents on conductors 4 and 5 being same in phase are intensified each other to become radiation currents. That is, resonance current contributes to radiation.

Also, as shown in FIG. 9C, the current on antenna device 1 at the secondary resonance frequency band has a substantially two times longer wavelength as against each conductor length. And, in first conductor 4 and second conductor 5, a current loop is formed at the end of feeder portion 3 and each tip 6, while a current node is formed at the middle point thereof. However, at the secondary resonance frequency band, the currents on conductors 4 and 5 are reverse in phase and canceled each other, which therefore resonate without contribution to radiation.

Furthermore, as shown in FIG. 9D, the current on antenna device 1 at the tertiary resonance frequency band has a substantially 4/3 times longer wavelength as against each conductor length. And, in first conductor 4 and second conductor 5, current loops are formed at the end of feeder portion 3 and the ⅔ position of the conductor length from the end of feeder portion 3, while current nodes are formed at each tip 6 and the ⅓ position of the conductor length from the end of feeder portion 3. At the tertiary resonance frequency band, the currents on conductors 4 and 5 being same in phase are intensified each other to become radiation currents. That is, resonance current contributes to radiation.

Next, a Smith chart showing impedance characteristics as the load side is viewed from feeder portion 3 of conventional antenna device 1 is shown in FIG. 10. As shown in FIG. 10, the impedance of antenna device 1 at the primary resonance frequency is shown by point Z1. Also, the impedance of antenna device 1 at the secondary resonance frequency is shown by point Z2. Further, the impedance of antenna device 1 at the tertiary resonance frequency is shown by point Z3.

As preceding technical document information related to the present invention, for example, Patent document 1 is commonly known.

However, conventional antenna device 1 includes the secondary resonance frequency band of which resonance current does not contributes to radiation between the primary resonance frequency band and the tertiary resonance frequency band of which resonance current contributes to radiation. And, the impedance of antenna device 1 at the primary resonance frequency band and the impedance of antenna device 1 at the tertiary resonance frequency band become too high. As a result, at the primary resonance frequency band and the tertiary resonance frequency band, it is difficult to make antenna device 1 match in impedance to the circuit connected to the latter stage of antenna device 1.

[Patent document 1] Unexamined Japanese Patent Publication 2005-203878.

### DISCLOSURE OF THE INVENTION

The antenna device of the present invention comprises a ground substrate serving as ground, a feeder portion formed on the ground substrate, a first conductor connected to the feeder portion, and a second conductor being substantially equal in length to the first conductor, which is connected to the ground substrate and disposed substantially parallel to the first conductor with a space therebetween. And, the first conductor and the second conductor are electrically connected to each other between each tip and a portion substantially at least ⅓ in length of each conductor from each tip.

Due to this configuration, the antenna device of the present invention is configured in that tertiary resonance frequency band ≦secondary resonance frequency band. Accordingly, in this antenna device, there is no secondary resonance frequency band that does not contribute to radiation between the primary resonance frequency band and the tertiary resonance frequency band contributing to radiation. And, it is possible to make the impedance of the antenna device inductive at the primary resonance frequency band, and the impedance of the antenna device capacitive at the tertiary resonance frequency band. Accordingly, at the primary resonance frequency band and the tertiary resonance frequency band at which the antenna device is actually used, it is possible to easily make the antenna device match in impedance to the circuit connected to the latter stage of the antenna device.

### BRIEF DESCRIPTION OF THE DRAWINGS

FIG. 1A is a schematic diagram showing an antenna device in the preferred embodiment 1 of the present invention and the configuration of electronic device using the device.

FIG. 1B is a schematic diagram for describing the current distribution at the primary resonance frequency band of the antenna device in the preferred embodiment 1 of the present invention.

FIG. 1C is a schematic diagram for describing the current distribution at the secondary resonance frequency band of the antenna device in the preferred embodiment 1 of the present invention.

FIG. 1D is a schematic diagram for describing the current distribution at the tertiary resonance frequency band of the antenna device in the preferred embodiment 1 of the present invention.

FIG. 2 is a Smith chart of the antenna device in the preferred embodiment 1 of the present invention.

FIG. 3A is a circuit diagram of the antenna device in the preferred embodiment 1 of the present invention.

FIG. 3B is a Smith chart showing the impedance characteristic of the antenna device in the preferred embodiment 1 of the present invention.

FIG. 3C is a chart showing the VSWR characteristic of the antenna device in the preferred embodiment 1 of the present invention.

FIG. 4A is another example of circuit diagram of the antenna device in the preferred embodiment 1 of the present invention.

FIG. 4B is a Smith chart showing the impedance characteristic of the antenna device in the preferred embodiment 1 of the present invention.

FIG. 4C is a chart showing the VSWR characteristic of the antenna device in the preferred embodiment 1 of the present invention.

FIG. 5A is further another example of circuit diagram of the antenna device in the preferred embodiment 1 of the present invention.

FIG. 5B is further another example of circuit diagram of the antenna device in the preferred embodiment 1 of the present invention.

FIG. 6A is a Smith chart showing the impedance characteristic of the antenna device in the preferred embodiment 1 of the present invention.

FIG. 6B is a chart showing the VSWR characteristic of the antenna device in the preferred embodiment 1 of the present invention.

FIG. 7A is further another example of circuit diagram of the antenna device in the preferred embodiment 1 of the present invention.

FIG. 7B is further another example of circuit diagram of the antenna device in the preferred embodiment 1 of the present invention.

FIG. 8A is further another example of circuit diagram of the antenna device in the preferred embodiment 1 of the present invention.

FIG. 8B is further another example of circuit diagram of the antenna device in the preferred embodiment 1 of the present invention.

FIG. 9A is a schematic diagram showing the configuration of a conventional antenna device.

FIG. 9B is a schematic diagram for describing the current distribution at the primary resonance frequency band of the conventional antenna device.

FIG. 9C is a schematic diagram for describing the current distribution at the secondary resonance frequency band of the conventional antenna device.

FIG. 9D is a schematic diagram for describing the current distribution at the tertiary resonance frequency band of the conventional antenna device.

FIG. 10 is a Smith chart of the conventional antenna device.

### DESCRIPTION OF THE REFERENCE NUMERALS AND SIGNS

7 Antenna device
8 Ground
9 Feeder portion
10 First conductor
11 Second conductor
12 Tip
13 Specified portion
14 Connection
15, 18, 21, 28, 31, 34 Matching circuit
22 Second reactance circuit
23 First reactance circuit
24 Second inductance circuit
25 Second capacitance circuit
26 First inductance circuit
27 First capacitance circuit
35 Fourth reactance circuit
36 Third reactance circuit
37 Fourth inductance circuit
38 Fourth capacitance circuit
39 Third capacitance circuit
40 Third inductance circuit
50 Feeding point
51 Wireless circuit
52 Display
60 Ground substrate

### DETAILED DESCRIPTION OF THE PREFERRED EMBODIMENTS

The preferred embodiments of the present invention will be described in the following with reference to the drawings.

### Preferred Embodiment 1

The preferred embodiment 1 of the present invention will be described in the following.

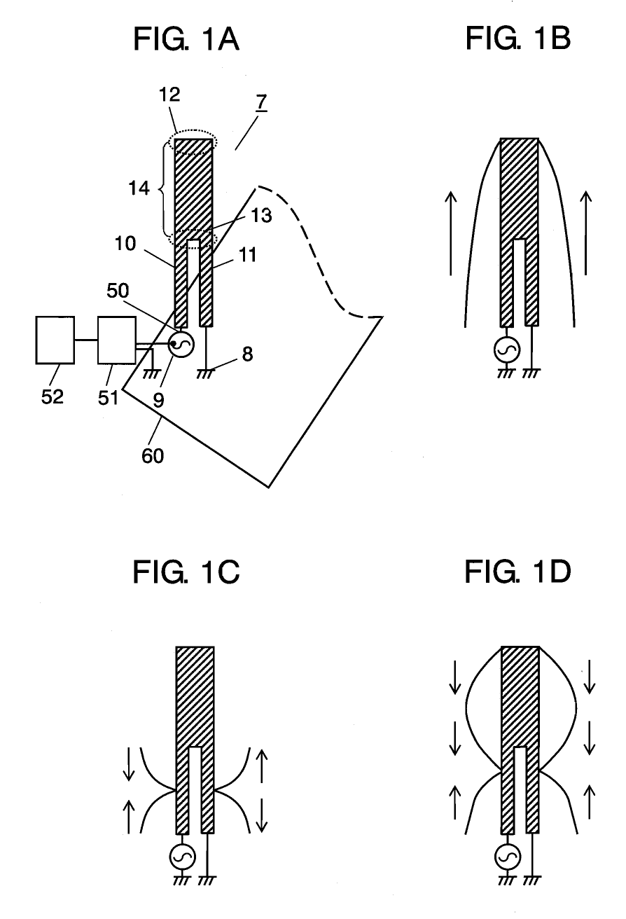

FIG. 1A is a schematic diagram of an antenna device 7 in the preferred embodiment 1 of the present invention and electronic device using antenna device 7. Antenna device 7 is installed on ground substrate 60 of a portable terminal. Ground substrate 60 plays the role of ground 8. As shown in FIG. 1A, antenna device 7 includes ground substrate 60 of a portable terminal, which serves as ground 8, feeder portion 9 formed on ground substrate 60 of the portable terminal, and first conductor 10 connected to feeder portion 9. Also, antenna device 7 includes second conductor 11 which is connected to ground substrate 60 and disposed substantially parallel to first conductor 10 with a space therebetween and substantially equal to first conductor 10 in conductor length. And, antenna device 7 includes connections 14 electrically connected to each other between each tip 12 of first conductor 10 and second conductor 11 and specified portion 13 substantially at least ⅓ in conductor length of first conductor 10 and second conductor 11 from each tip 12. Electronic device mounted with antenna device 7 includes wireless circuit 51 connected to feeding point 50 of feeder portion 9 and display 52 connected to wireless circuit 51. In FIG. 1A, antenna device 7 is installed in a vertical fashion to the plane of ground substrate 60, but it is also allowable to install antenna device 7 in a horizontal fashion to the plane of ground substrate 60. Also, it is preferable to install antenna device 7 so as to be properly angled to the plane of ground substrate 60.

The operation of antenna device 7 will be described in the following.

FIG. 1B is a schematic diagram for describing the current distribution at the primary resonance frequency band of antenna device 7 in the preferred embodiment 1 of the present invention. As shown in FIG. 1B, the current on antenna device 7 at the primary resonance frequency band has a substantially four times longer wavelength as against the whole of each conductor length. And, in first conductor 10, a current loop is formed at the end of feeder portion 9, and a current node is formed at tip 12 of first conductor 10. Similarly, in second conductor 11, a current loop is formed at the end of ground 8, and a current node is formed at tip 12 of second conductor 11. And, at the primary resonance frequency band, the currents on first conductor 10 and second conductor 11 are same in phase and intensified each other to become radiation currents. And, the resonance current contributes to radiation. Also, at the primary resonance frequency, the currents on first conductor 10 and second conductor 11 at connection 14 are same in direction and level because of symmetry, which are therefore free from interfering with each other.

Also, the current on antenna device 7 at the secondary resonance frequency band, as shown in FIG. 1C, has a substantially two times longer wavelength as against each conductor length between specified portion 13 and the end of feeder portion 9. And, in first conductor 10, current loops are formed at the end of feeder portion 9 and specified portion 13, while a current node is formed at the middle point between the end of feeder portion 9 and specified portion 13. Similarly, in second conductor 11, current loops are formed at the end of ground 8 and specified portion 13, while a current node is formed at the middle point between the end of ground 8 and specified portion 13. However, at the secondary resonance frequency band, the currents on first conductor 10 and second conductor 11 are reverse in phase and canceled each other. Therefore, resonance takes place but there is no contribution to radiation. In this way, at the secondary resonance frequency band, the currents on first conductor 10 and second conductor 11 at connection 14 being same in level and reverse in direction are canceled each other. As a result, apparently the current does not flow in connection 14 but between the end of feeder portion 9 and specified portion 13.

Further, the current on antenna device 7 at the tertiary resonance frequency band, as shown in FIG. 1D, has a substantially 4/3 times longer wavelength as against the whole of each conductor length. And, in first conductor 10, current loops are formed at the end of feeder portion 9 and the ⅔ position of conductor length from the end of feeder portion 9, while current nodes are formed at tip 12 of first conductor 10 and the ⅓ position of conductor length from the end of feeder portion 9. Similarly, in second conductor 11, current loops are formed at the end of ground 8 and the ⅔ position of conductor length from the end of ground 8, while current nodes are formed at tip 12 of second conductor 11 and the ⅓ position of conductor length from the end of ground 8. At the tertiary resonance frequency band, the currents on first conductor 10 and second conductor 11 are same in phase and intensified each other to become radiation current. And, the resonance current contributes to radiation. Also at the tertiary resonance frequency band, the currents on first conductor 10 and second conductor 11 at connection 14 being same in direction and level because of symmetry, which are therefore free from interfering with each other.

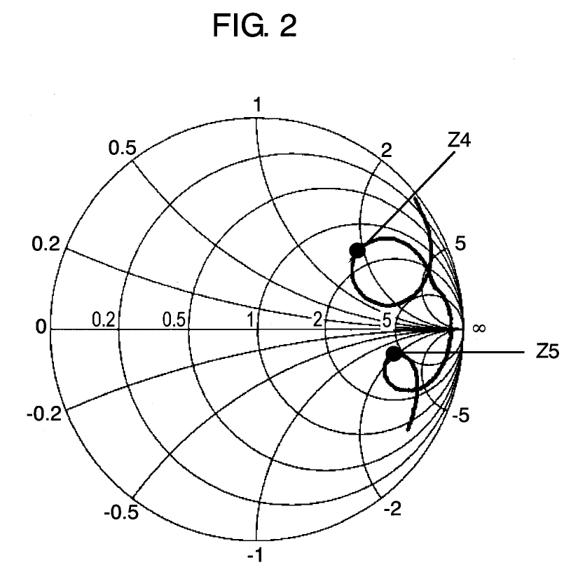

FIG. 2 is a Smith chart showing the impedance characteristic of antenna device 7 of the present invention. As shown in FIG. 2, the impedance of antenna device 7 at the primary resonance frequency is shown by point Z4. Also, the impedance of antenna device 7 at the tertiary resonance frequency is shown by point Z5. Thus, in antenna device 7 of the present invention, the primary resonance frequency band and the tertiary resonance frequency band remain rather unchanged as compared with the conventional configuration, and only the secondary resonance frequency band becomes higher. That is, there exists no secondary resonance frequency band that does not contribute to radiation between the primary resonance frequency band and the secondary resonance frequency band. Further, it is possible to make the impedance of antenna device 7 inductive at the primary resonance frequency band, and also, the impedance of antenna device 7 capacitive at the tertiary resonance frequency band. Accordingly, at the primary resonance frequency band and the tertiary resonance frequency band at which antenna device 7 is actually used, it is possible to easily make antenna device 7 match in impedance to the circuit connected to the latter stage of antenna device 7.

Further, first conductor 10 and second conductor 11 are flat in shape, and when they are disposed with the surfaces opposed to each other, the level of radiation resistance of antenna device 7 can be effectively adjusted by changing the area ratio of first conductor 10 to second conductor 11 confronting each other at the primary resonance frequency band and the tertiary resonance frequency band. This is because the change in area ratio of the surfaces confronting each other causes the ratio of the radiation current flowing in first conductor 10 connected to feeder portion 9 to the radiation current flowing in second conductor 11 connected to ground 8 to be changed, enabling the adjustment of the level of radiation resistance. In this way, it is possible to more easily make antenna device 7 match in impedance to the circuit connected to the latter stage of antenna device 7.

The matching circuit connected to antenna device 7 will be described in the following.

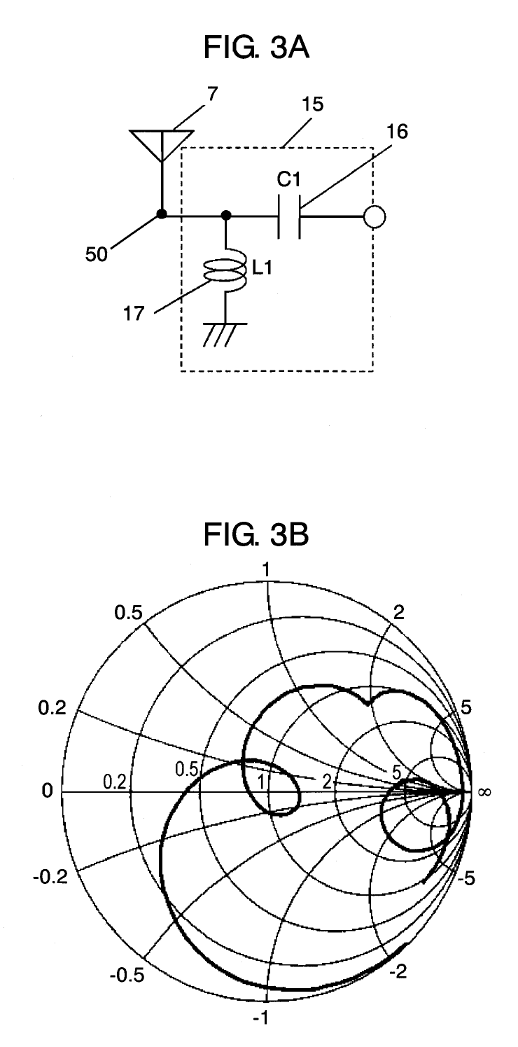

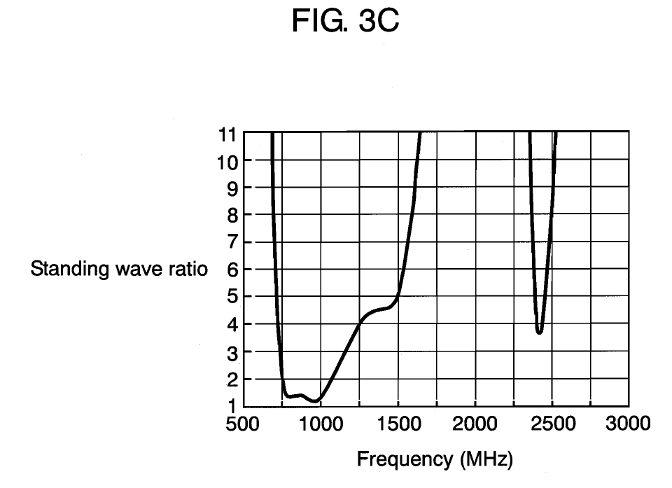

First, for making antenna device 7 match in impedance to the circuit connected to the latter stage of antenna device 7 at the primary resonance frequency band, as shown in FIG. 3A, described here is the case of connecting HPF (High Pass Filter) type matching circuit 15 to feeder portion 9 of antenna device 7, as shown in FIG. 3A. HPF type matching circuit 15 includes inductance circuit 17 of inductance value L1 connected between feeding point 50 and ground 8 of antenna device 7, and capacitance circuit 16 of capacitance value C1 connected to feeding point 50 of antenna device 7. Also, with the impedance of antenna device 7 at the primary resonance frequency band matched by the HPF type matching circuit 15, the impedance characteristic and the VSWR characteristic of antenna device 7 are respectively shown in FIG. 3B and FIG. 3C.

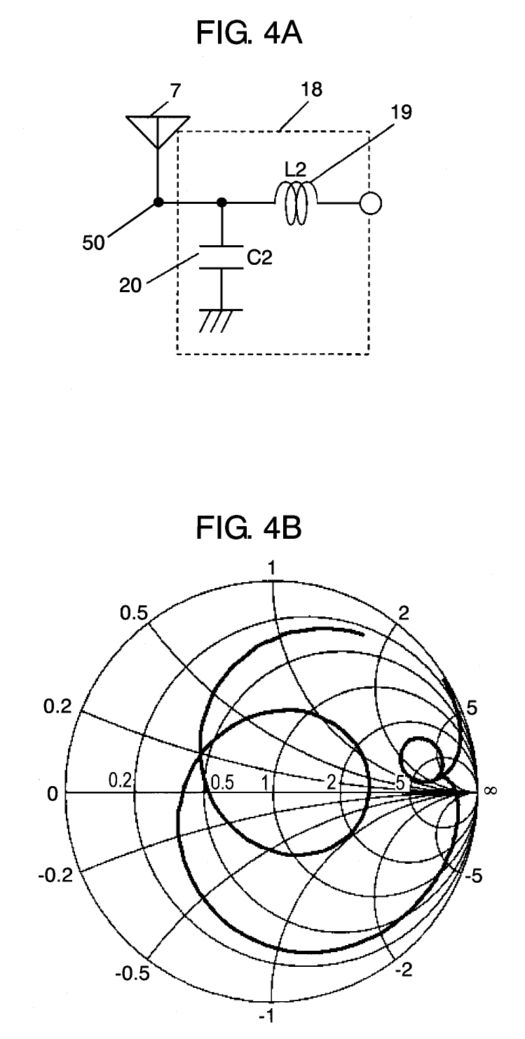

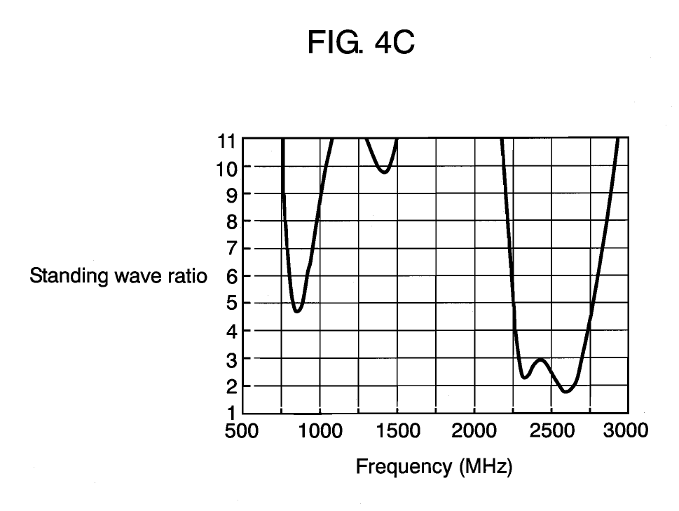

Next, for making antenna device 7 match in impedance to the circuit connected to the latter stage of antenna device 7 at the tertiary resonance frequency band, as shown in FIG. 4A, described here is the case of connecting LPF (Low Pass Filter) type matching circuit 18 to feeder portion 9 of antenna device 7, as shown in FIG. 4A. LPF type matching circuit 18 includes capacitance circuit 20 of capacitance value C2 connected between feeding point 50 and ground 8 of antenna device 7, and inductance circuit 19 of inductance value L2 connected to feeding point 50 of antenna device 7. Also, with the impedance of antenna device 7 at the tertiary resonance frequency band matched by the LPF type matching circuit 18, the impedance characteristic and the VSWR characteristic are respectively shown in FIG. 4B and FIG. 4C.

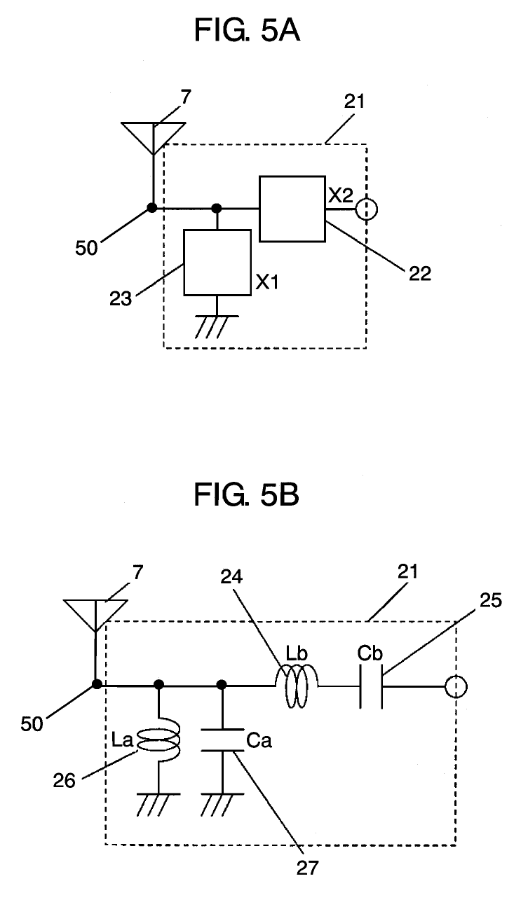

Here, as shown in FIG. 5A, suppose that matching circuit 21 connected to feeder portion 9 of antenna device 7 comprises first reactance circuit 23 of reactance value X1 connected between feeding point 50 and ground 8 of antenna device 7, and second reactance circuit 22 of reactance value X2 connected to feeding point 50 of antenna device 7. In this case, when X1=ωL1 and also X2=−1/(ωC1) at the primary resonance frequency, and X1=−1/(ωC2) and also X2=ωL2 at the tertiary resonance frequency, then at both of the primary resonance frequency band and the tertiary resonance frequency band, antenna device 7 can be matched in impedance to the circuit connected to the latter stage of antenna device 7. That is, it is preferable that first reactance circuit 23 of reactance value X1 becomes inductive and also second reactance circuit 22 of reactance value X2 becomes capacitive at the primary resonance frequency band of antenna device 7, while first reactance circuit 23 of reactance value X1 becomes capacitive and also second reactance circuit 22 of reactance value X2 becomes inductive at the tertiary resonance frequency band of antenna device 7.

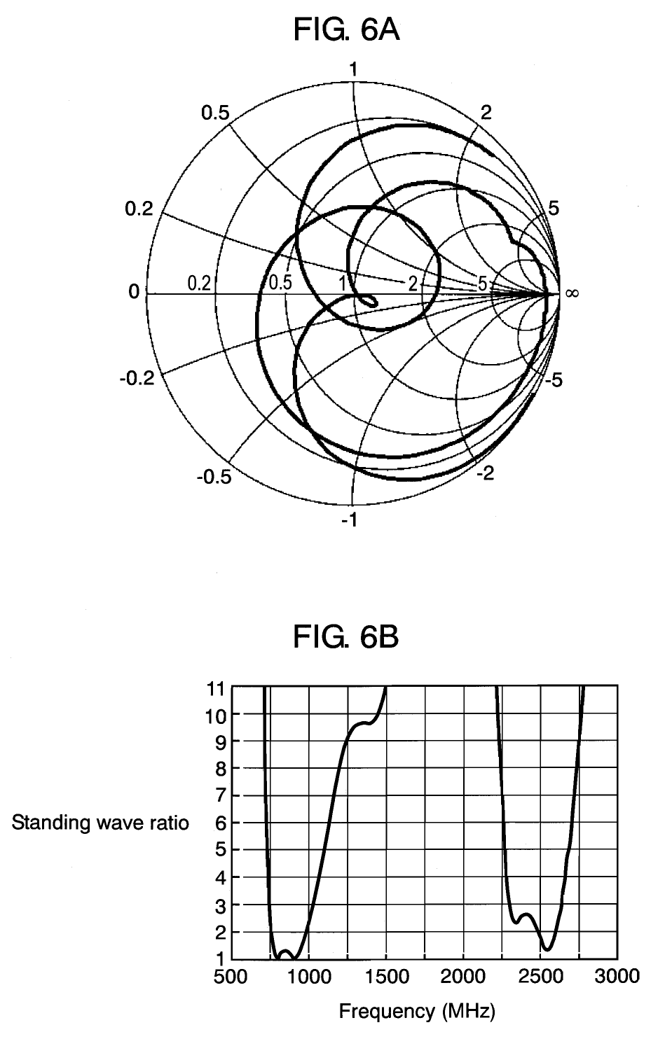

Matching circuit 21 can be specifically realized by BPF (Band Pass Filter) type matching circuit 21 as shown in FIG. 5B. BPF type matching circuit 21 includes a parallel circuit formed of first inductance circuit 26 of inductance value La and first capacitance circuit 27 of capacitance value Ca which are connected between feeding point 50 and ground 8 of antenna device 7, and a series circuit formed of second inductance circuit 24 of inductance value Lb and second capacitance circuit 25 of capacitance value Cb which are connected to feeding point 50 of antenna device 7. Here, it is designed so that Ca, La, Cb, and Lb satisfy the following conditions. That is, at the primary resonance frequency, ωCa−1/(ωLa)=−1/(ωL1), and ωLb−1/(ωCb)=−1/(ωC1). Also, at the tertiary resonance frequency, ωCa−1/(ωLa)=ωC2, and ωLb−1/(ωCb)=ωL2. The impedance characteristic and VSWR characteristic of antenna device 7 with matching circuit 21 connected thereto are respectively shown in FIG. 6A and FIG. 6B. As shown in FIG. 6B, at the two frequency bands of 800 MHz band and 2400 MHz band, matching circuit 21 can be designed so as to have a low standing wave ratio. Thus, by connecting the matching circuit 21 that satisfies the above relative equations to antenna device 7, it is possible to make antenna device 7 at both of the primary resonance frequency band and the tertiary resonance frequency band match the circuit connected to the latter stage of antenna device 7 and to widen the operating frequency band of antenna device 7.

Also, antenna device 7 can be used for a portable terminal using a communication system in which two frequency bands as mentioned above are used in common. In that case, the signal transmitted and received by antenna device 7 is processed by wireless circuit 51. And, display 52 is able to display the transmitted and received information. It is easy to properly select the frequency band and resonance frequency of antenna device 7 in accordance with the communication system.

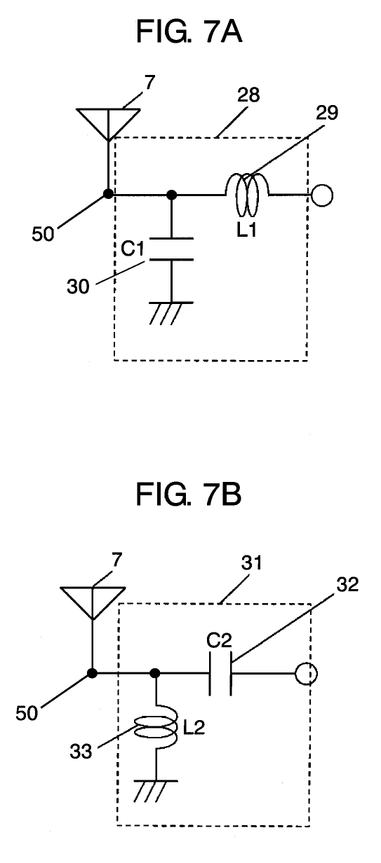

Next, for making antenna device 7 match in impedance to the circuit connected to the latter stage of antenna device 7 at the primary resonance frequency band, as shown in FIG. 7A, described here is the case of connecting LPF type matching circuit 28 to antenna device 7. LPF type matching circuit 28 includes capacitance circuit 30 of capacitance value C1 connected between feeding point 50 and ground 8 of antenna device 7, and inductance circuit 29 of inductance value L1 connected to feeding point 50 of antenna device 7.

Next, for making antenna device 7 match in impedance to the circuit connected to the latter stage of antenna device 7 at the tertiary resonance frequency band, as shown in FIG. 7B, described here is the case of connecting HPF type matching circuit 31 to feeder portion 9 of antenna device 7. HPF type matching circuit 31 includes inductance circuit 33 of inductance value L2 connected between feeding point 50 and ground 8 of antenna device 7, and capacitance circuit 32 of capacitance value C2 connected to feeding point 50 of antenna device 7.

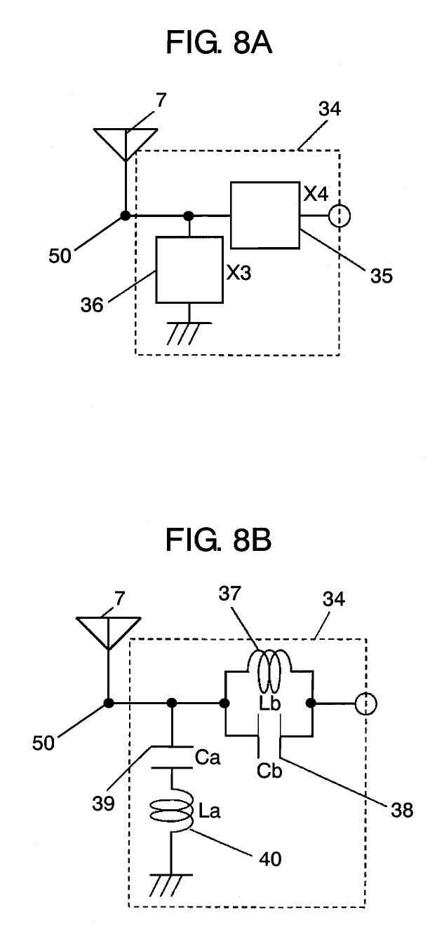

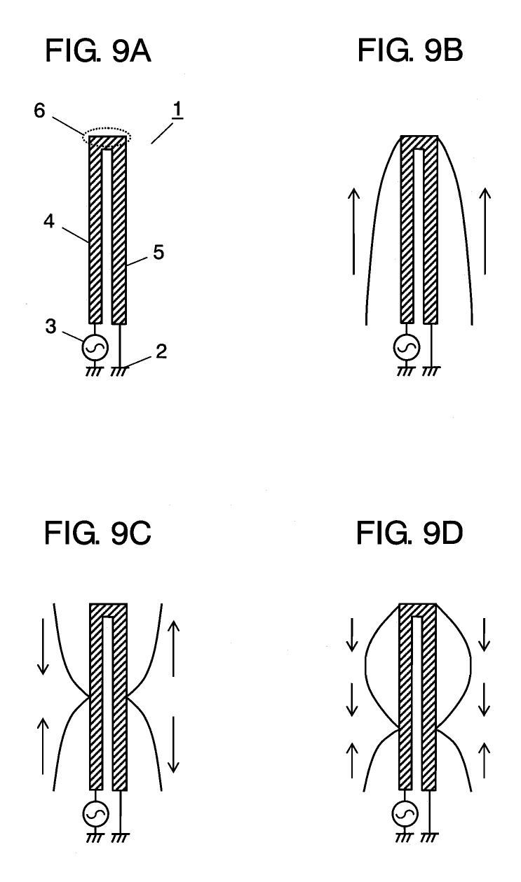

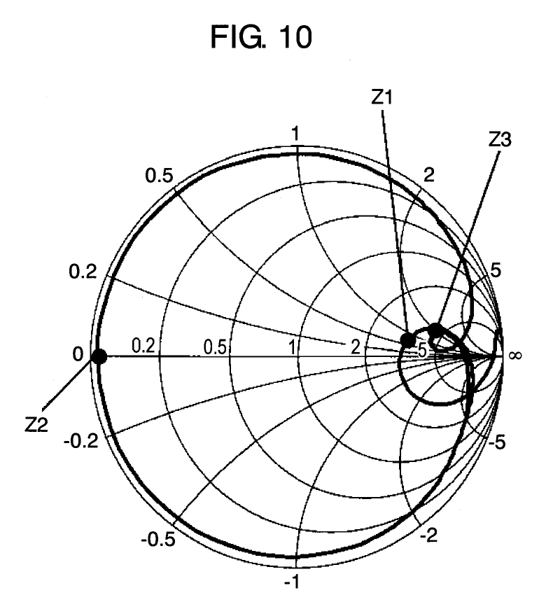

Here, as shown in FIG. 8A, suppose that matching circuit 34 connected to feeder portion 9 of antenna device 7 comprises third reactance circuit 36 of reactance value X3 connected between feeding point 50 and ground 8 of antenna device 7, and fourth reactance circuit 35 of reactance value X4 connected to feeding point 50 of antenna device 7. In this case, when X3=−1/(ωC1) and also X4=ωL1 at the primary resonance frequency band, and X3=ωL2 and also X4=−1/(ωC2) at the tertiary resonance frequency band, then at both of the primary resonance frequency band and the tertiary resonance frequency band, antenna device 7 can be matched to the circuit connected to the latter stage of antenna device 7. That is, it is preferable that third reactance circuit 36 of reactance value X3 becomes capacitive and also fourth reactance circuit 35 of reactance value X4 becomes inductive at the primary resonance frequency band of antenna device 7, while third reactance circuit 36 of reactance value X3 becomes inductive and also fourth reactance circuit 35 of reactance value X4 becomes capacitive at the tertiary resonance frequency band of antenna device 7.

Matching circuit 34 can be specifically realized by BRF (Band Reject Filter) type matching circuit 34 as shown in FIG. 8B. BRF type matching circuit 34 includes a series circuit formed of third capacitance circuit 39 of capacitance value Ca and third inductance circuit 40 of inductance value La which are connected between feeding point 50 and ground 8 of antenna device 7, and a parallel circuit formed of fourth inductance circuit 37 of inductance value Lb and fourth capacitance circuit 38 of capacitance value Cb which are connected to feeding point 50 of antenna device 7. Here, it is designed so that Ca, La, Cb, and Lb satisfy the following conditions. That is, at the primary resonance frequency, ωLa−1/(ωCa)=−1/(ωC1), and ωCb−1/(ωLb)=−1/(ωL1). Also, at the tertiary resonance frequency, ωLa−1/(ωCa)=ωL2, and ωCb−1/(ωLb)=ωC2. Thus, by connecting the matching circuit 34 that satisfies the above relative equations to antenna device 7, it is also possible to make antenna device 7 at both of the primary resonance frequency band and the tertiary resonance frequency band match the circuit connected to the latter stage of antenna device 7 and to widen the operating frequency band of antenna device 7.

The matching circuit connected to antenna device 7 is preferable to have a configuration other than the above-mentioned, which is for example formed of a capacitance circuit and an inductance circuit series-connected to antenna device 7. In this way, it is possible to reduce the size of the matching circuit.

### INDUSTRIAL APPLICABILITY

As described above, the antenna device of the present invention is able to easily make the antenna device match in impedance to the circuit connected to the latter stage of the antenna device at the primary resonance frequency band and the tertiary resonance frequency band, which is therefore useful to be used in electronic device such as portable terminal and receiver for motorcar in particular.

1. An antenna device comprising:
a ground substrate serving as ground,
a feeder portion formed on the ground substrate;
a first conductor connected to the feeder portion; and
a second conductor which is connected to the ground substrate and disposed substantially parallel to the first conductor with a space therebetween and substantially equal to the first conductor in conductor length,
wherein the first conductor and the second conductor are electrically connected to each other between each tip of the first conductor and the second conductor and a specified portion substantially at least ⅓ in conductor length of the first conductor and the second conductor from each tip.

2. The antenna device of claim 1 further comprising:
a matching circuit connected to the feeder portion, the matching circuit including:
a first reactance circuit connected between a feeding point of the feeder portion and the ground; and
a second reactance circuit connected to the feeding point of the feeder portion,
wherein the first reactance circuit becomes inductive and the second reactance circuit becomes capacitive at a primary resonance frequency band of the antenna device, and
the first reactance circuit becomes capacitive and the second reactance circuit becomes inductive at a tertiary resonance frequency band of the antenna device.

3. The antenna device of claim 2,
wherein the matching circuit includes
a parallel circuit formed of a first inductance circuit and a first capacitance circuit which are connected between a feeding point of the feeder portion and the ground, and
a series circuit formed of a second inductance circuit and a second capacitance circuit which are connected to a feeding point of the feeder portion.

4. The antenna device of claim 1 further comprising:
a matching circuit connected to the feeder portion, the matching circuit including:
a third reactance circuit connected between a feeding point of the feeder portion and the ground; and
a fourth reactance circuit connected to the feeding point of the feeder portion,
wherein the third reactance circuit becomes capacitive and the fourth reactance circuit becomes inductive at a primary resonance frequency band of the antenna device, and
the third reactance circuit becomes inductive and the fourth reactance circuit becomes capacitive at a tertiary resonance frequency band of the antenna device.

5. The antenna device of claim 4,
wherein the matching circuit includes
a series circuit formed of a third inductance circuit and a third capacitance circuit which are connected between a feeding point of the feeder portion and the ground, and
a parallel circuit formed of a fourth inductance circuit and a fourth capacitance circuit which are connected to a feeding point of the feeder portion.

6. The antenna device of claim 1,
wherein the first conductor and the second conductor are flat in shape and confronted each other with their surfaces.

7. Electronic device comprising:
a ground substrate serving as ground,
a feeder portion formed on the ground substrate;
a first conductor connected to the feeder portion;
a second conductor which is connected to the ground substrate and disposed substantially parallel to the first conductor with a space therebetween and substantially equal to the first conductor in conductor length;
a wireless circuit connected to the feeder portion; and
a display connected to the wireless circuit,
wherein the first conductor and the second conductor are electrically connected to each other between each tip of the first conductor and the second conductor and a portion substantially at least ⅓ in conductor length of the first conductor and the second conductor from each tip.
